(19) United States
(12) Patent Application Publication
(10) Pub. No.: US 2024/0268287 A1
(43) Pub. Date: Aug. 15, 2024

(54) Individual Houseplant Solar Powered Watering System

(71) Applicant: John Ramm, Greenword, SC (US)

(72) Inventor: John Ramm, Greenword, SC (US)

(21) Appl. No.: 18/108,634

(22) Filed: Feb. 12, 2023

(51) Int. Cl. A01G 27/00

(52) U.S. Cl. CPC A01G 27/003; A01G 27/001; A01G 27/005; A01G 27/008

(57) ABSTRACT

The present subject matter is solar powered watering system for houseplants. Solar power recharges batteries that run a pump for a measured amount of water from a reservoir that is dispensed onto a houseplant on a daily basis. This eliminates the daily maintenance on house plants and simplifies plant care.

### FIELD OF THE INVENTION

The present subject matter deals with houseplants and the maintenance thereof by providing water to the plant on a regularly timed schedule.

### BACKGROUND OF THE INVENTION

Prior to the present subject matter, indoor plant enthusiasts would have to remember to water their plants each day. This could result in plants becoming dehydrated. The present subject matter ensures that the plant is given the appropriate amount of water on a daily basis. It allows indoor plant enthusiasts to take vacations without worrying about their plants. In addition, the present subject matter is beneficial to working professionals and the elderly.

### SUMMARY OF THE INVENTION

The present subject matter comprises of a snap on lid 1, solar panel 2, rechargeable batteries 3, a slip in container 4, electronic circuit board 5, digital timer 6, low water indicator light 7, UV water sanitizer light 8, feeder hose 9, low water indicator 10, clip to hold feeder the feeder hose 11, straight feeder hose attached to the pump 12, water fill spout 13, small water pump 14, bottom section water reservoir 15, and a chain with an “S” hook to attached to hanging plants 16.

The snap on lid allows for the average houseplant to sit on top of the apparatus. The solar panel allows for providing energy to the rechargeable batters. The slip in container holds most of the mechanical items and prevents any type of electrical issues due to water. The electronic circuit board controls the digital timer, low water indicator light, UV light, small water pump and low water indicator.

The low water indicator light turns one when the bottom section water reservoir is ready to be refilled. The ultraviolet water sanitizer light helps prevent microorganisms from building up in the water and causing issues with the household plant. The feeder hose to the plant supplies water to the plant from the water reservoir.

The low water indicator sends a signal to the low water indicator light through the circuit board to alert the user that it's time to refill the reservoir. The clip to hold the feeder hose is adjustable and prevents the hose from coming loose or spilling someplace than onto the houseplant's soil.

The water fill spout is used to replenish the water in the bottom section water reservoir. The small water pump is how the water is transported from the bottom section water reservoir to the household plant and the chain with “S” hooks allow for the apparatus to be used with hanging plants.

In some embodiments the electronics are sealed in a top container to prevent any type of water damage.

The apparatus is designed in a manner such that the reservoir can be refilled without having to take it down or remove the plant.

In some embodiments, the timer can be set to release water at regularly scheduled intervals. Midnight is typically recommended and in a volume that equals one half of the volume of the pot per week.

In some embodiments, the pump runs for 15 seconds and delivers four ounces of water. However, this may be altered based on the needs of the plant.

In some embodiments, the reservoir holds 48 ounces of water or a twelve-day supply for most houseplants. The reservoir is also equipped with an ultraviolet light that activates when the pump is running to assist in killing microorganisms in the water.

The apparatus works with both hanging and non-hanging plants, the batteries charge with indoor lighting in addition to natural light, and liquid fertilizers may be added to the water reservoir.

### BRIEF DESCRIPTION OF THE INVENTION

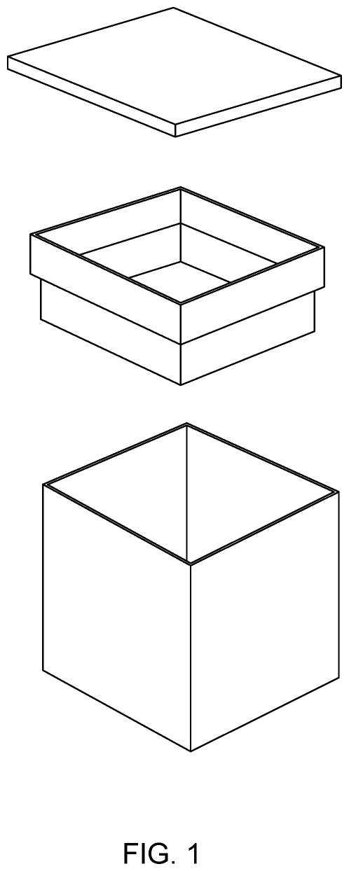

FIG. 1 shows a perspective view of the snap on lid 1 to place a household plant in a pot onto, the slip in container 4 that holds most of the mechanical items, and the bottom section water reservoir 15.

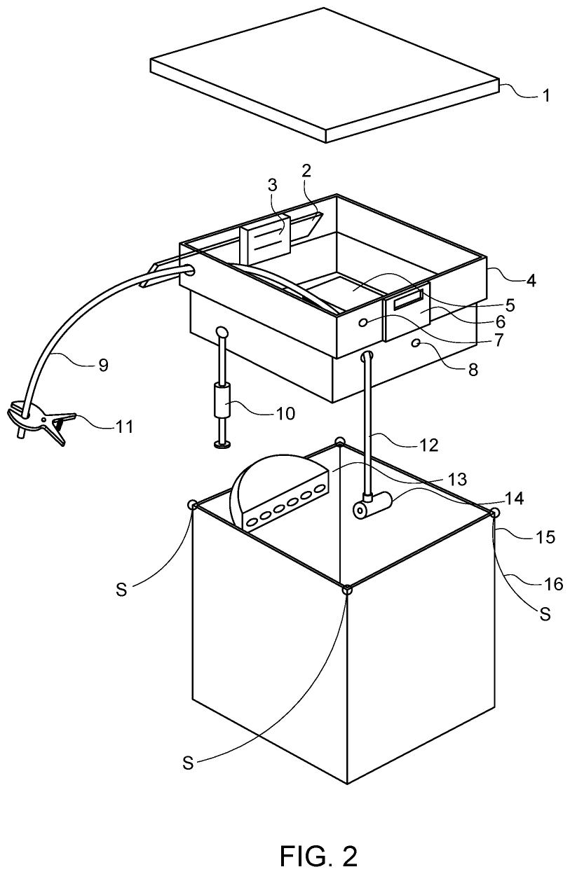

FIG. 2 shows a perspective view of the apparatus.

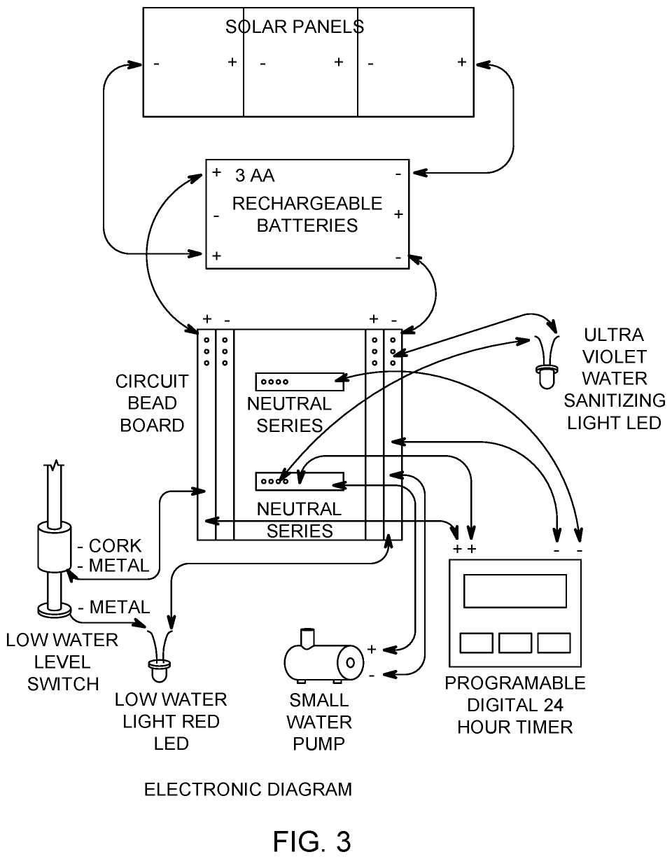

FIG. 3. Shows an electronic diagram of the circuit board.

### DETAILED DESCRIPTION OF THE INVENTION

FIG. 1 shows a perspective view of the snap on lid 1 to place a household plant in a pot onto, the slip in container 4 that holds most of the mechanical items, and the bottom section water reservoir 15.

FIG. 2 shows a perspective view of a snap on lid 1, solar panel 2, rechargeable batteries 3, a slip in container 4, electronic circuit board 5, digital timer 6, low water indicator light 7, UV water sanitizer light 8, feeder hose 9, low water indicator 10, clip to hold feeder the feeder hose 11, straight feeder hose attached to the pump 12, water fill spout 13, small water pump 14, bottom section water reservoir 15, and a chain with an “S” hook to attached to hanging plants 16.

FIG. 3 shows an electronic diagram of the circuit board wherein the solar panels connect to the rechargeable batteries. The rechargeable batteries connect to the circuit board. The circuit board connects to the ultra violet water sanitizing light, the programmable digital timer, small water pump, low water light, and low water level switch.

We claim:

1. A solar powered houseplant watering system comprising of a snap on lid 1, solar panel 2, rechargeable batteries 3, a slip in container 4, electronic circuit board 5, digital timer 6, low water indicator light 7, UV water sanitizer light 8, feeder hose 9, low water indicator 10, clip to hold feeder the feeder hose 11, straight feeder hose attached to the pump 12, water fill spout 13, small water pump 14, bottom section water reservoir 15, and a chain with an “S” hook to attached to hanging plants 16.

2. The solar powered houseplant watering system comprising of the snap on lid 1, solar panel 2, rechargeable battery holder 3, a slip in container 4, electronic circuit board 5, digital timer 6, low water indicator light 7, UV water sanitizer light 8, feeder hose 9, low water indicator 10, clip to hold feeder the feeder hose 11, straight feeder hose attached to the pump 12, water fill spout 13, small water pump 14, bottom section water reservoir 15, and a chain with an “S” hook to attached to hanging plants 16 as in claim 1, wherein the circuit board 5 to instruct the small water pump 14 to disperse water from the bottom section water reservoir;

3. The solar powered houseplant watering system comprising of a snap on lid 1, solar panel 2, rechargeable battery holder 3, a slip in container 4, electronic circuit board 5, digital timer 6, low water indicator light 7, UV water sanitizer light 8, feeder hose 9, low water indicator 10, clip to hold feeder the feeder hose 11, straight feeder hose attached to the pump 12, water fill spout 13, small water pump 14, bottom section water reservoir 15, and a chain with an “S” hook to attached to hanging plants 16 as in claim 1, wherein the digital timer 6 allows for regimented watering;

4. The solar powered houseplant watering system comprising of a snap on lid 1, solar panel 2, rechargeable battery holder 3, a slip in container 4, electronic circuit board 5, digital timer 6, low water indicator light 7, UV water sanitizer light 8, feeder hose 9, low water indicator 10, clip to hold feeder the feeder hose 11, straight feeder hose attached to the pump 12, water fill spout 13, small water pump 14, bottom section water reservoir 15, and a chain with an “S” hook to attached to hanging plants 16 as in claim 1, wherein the ultraviolet light 8 sanitizes the water;

5. The solar powered houseplant watering system comprising of a snap on lid 1, solar panel 2, rechargeable battery holder 3, a slip in container 4, electronic circuit board 5, digital timer 6, low water indicator light 7, UV water sanitizer light 8, feeder hose 9, low water indicator 10, clip to hold feeder the feeder hose 11, straight feeder hose attached to the pump 12, water fill spout 13, small water pump 14, bottom section water reservoir 15, and a chain with an “S” hook to attached to hanging plants 16 as in claim 1, wherein the low water indicator light 7 shows when the bottom section water reservoir 15 needs to be refilled.

6. A method of constructing a solar powered houseplant watering system comprising of a snap on lid 1, solar panel 2, rechargeable batteries 3, a slip in container 4, electronic circuit board 5, digital timer 6, low water indicator light 7, UV water sanitizer light 8, feeder hose 9, low water indicator 10, clip to hold feeder the feeder hose 11, straight feeder hose attached to the pump 12, water fill spout 13, small water pump 14, bottom section water reservoir 15, and a chain with an “S” hook to attached to hanging plants 16.

7. A method of constructing a solar powered houseplant watering system comprising of a snap on lid 1, solar panel 2, rechargeable batteries 3, a slip in container 4, electronic circuit board 5, digital timer 6, low water indicator light 7, UV water sanitizer light 8, feeder hose 9, low water indicator 10, clip to hold feeder the feeder hose 11, straight feeder hose attached to the pump 12, water fill spout 13, small water pump 14, bottom section water reservoir 15, and a chain with an “S” hook to attached to hanging plants 16 as in claim 6, wherein the circuit board 5 to instruct the small water pump 14 to disperse water from the bottom section water reservoir;

8. A method of constructing a solar powered houseplant watering system comprising of a snap on lid 1, solar panel 2, rechargeable batteries 3, a slip in container 4, electronic circuit board 5, digital timer 6, low water indicator light 7, UV water sanitizer light 8, feeder hose 9, low water indicator 10, clip to hold feeder the feeder hose 11, straight feeder hose attached to the pump 12, water fill spout 13, small water pump 14, bottom section water reservoir 15, and a chain with an “S” hook to attached to hanging plants 16 as in claim 6, wherein the digital timer 6 allows for regimented watering;

9. A method of constructing a solar powered houseplant watering system comprising of a snap on lid 1, solar panel 2, rechargeable batteries 3, a slip in container 4, electronic circuit board 5, digital timer 6, low water indicator light 7, UV water sanitizer light 8, feeder hose 9, low water indicator 10, clip to hold feeder the feeder hose 11, straight feeder hose attached to the pump 12, water fill spout 13, small water pump 14, bottom section water reservoir 15, and a chain with an “S” hook to attached to hanging plants 16 as in claim 6, wherein the ultraviolet light 8 sanitizes the water;

10. A method of constructing a solar powered houseplant watering system comprising of a snap on lid 1, solar panel 2, rechargeable batteries 3, a slip in container 4, electronic circuit board 5, digital timer 6, low water indicator light 7, UV water sanitizer light 8, feeder hose 9, low water indicator 10, clip to hold feeder the feeder hose 11, straight feeder hose attached to the pump 12, water fill spout 13, small water pump 14, bottom section water reservoir 15, and a chain with an “S” hook to attached to hanging plants 16 as in claim 6, wherein the low water indicator light 7 shows when the bottom section water reservoir 15 needs to be refilled.
